(19) United States
(12) Patent Application Publication
(10) Pub. No.: US 2026/0152867 A1
(43) Pub. Date: Jun. 4, 2026

(54) COOLING TABLE FOR ANODES

(71) Applicant: RIO TINTO ALCAN INTERNATIONAL LIMITED, Montréal (CA)

(72) Inventors: Jean-Nicolas MALTAIS, Chicoutimi (CA); Jonathan BERNIER, Chicoutimi (CA); Marius ALLAIRE, Saint-David-de-Falardeau (CA); Philippe BERGERON, Laterrière (CA)

(21) Appl. No.: 18/290,884

(22) PCT Filed: Jul. 28, 2022
(86) PCT No.: PCT/CA2022/051158

§ 371 Date: Jan. 22, 2024

Related U.S. Application Data
(60) Provisional application No. 63/226,277, filed on Jul. 28, 2021.

(51) Int. Cl. C25C 3/12; C25C 3/10; C25C 7/06

(52) U.S. Cl. CPC C25C 3/125; C25C 3/10; C25C 7/06

(57) ABSTRACT

An anode cooling table for supporting anodes during cooling, has: a frame; a heat absorbing layer defining a substantially continuous surface for being contacted with the anodes; and a heat diffusing layer in contact with the frame and disposed between the frame and the heat absorbing layer, the heat absorbing layer in heat exchange relationship with the frame through the heat diffusing layer.

### TECHNICAL FIELD

This disclosure generally relates to the field of aluminum reduction cell and process used to process carbonaceous anodes for aluminum smelting and, more particularly, to systems and methods used to cool down those carbonaceous anodes after they are taken out of the cell.

### BACKGROUND OF THE ART

Aluminum reduction cell and process comprise a plurality of chambers containing anodes. These anodes are exposed to temperature of about 950-970 degrees Celsius during the aluminum smelting process. At some point, the spent anodes are taken out of the aluminum reduction cell and left to cool down. However, because of their high temperatures, they emanate hydrogen fluoride (HF). The hotter the anodes, the more HF they emanate. Current regulations may limit HF emissions. Hence, efforts to increase production of aluminum may be impaired by the excessive emissions of HF. Improvements are therefore sought.

### SUMMARY

In one aspect, there is provided an anode cooling table for supporting anodes during cooling, comprising: a frame; a heat absorbing layer defining a substantially continuous surface for being contacted with the anodes; and a heat diffusing layer in contact with the frame and disposed between the frame and the heat absorbing layer, the heat absorbing layer in heat exchange relationship with the frame through the heat diffusing layer.

The anode cooling table described above may include any of the following features, in any combinations.

In some embodiments, the anode cooling table has at least one slab secured to the frame, the at least one slab having a top face for contacting the anodes and a bottom face opposed to the top face and facing the frame, the heat absorbing layer defined by a first portion of the at least one slab extending from the top face towards the bottom face, the heat diffusing layer defined by a second portion of the at least one slab extending from the bottom face towards the top face.

In some embodiments, the anode cooling table has a plurality of slabs secured to the frame, the plurality of slabs having top faces for contacting the anodes and bottom faces facing the frame.

In some embodiments, the anode cooling table has expansion joints disposed between each two adjacent ones of the plurality of slabs, the expansion joints resiliently deformable in a direction parallel to the top faces of the plurality of slabs.

In some embodiments, each of the plurality of slabs has peripheral faces extending from the top faces to the bottom faces and chamfers at intersections between the top faces and the peripheral faces.

In some embodiments, the anode cooling table has a securing arrangement for securing the plurality of slabs to the frame, the securing arrangement including cleats in abutment against the chamfers and fasteners extending through the cleats and threadingly engaged to the frame.

In some embodiments, the securing arrangement includes biasing washers disposed between heads of the fasteners and the cleats, the biasing washers allowing vertical motions of the plurality of slabs in relationship to the frame about an axis perpendicular to the top faces.

In some embodiments, the anode cooling table has biasing members disposed between the plurality of slabs and the frame, the plurality of slabs movable in a vertical direction normal to the plurality of slabs by resilient deformation of the biasing members.

In some embodiments, the biasing members are linear wave springs.

In some embodiments, the bottom faces of the plurality of slabs define grooves.

In some embodiments, the frame has a length in a longitudinal direction and a width in a transverse direction, the length greater than the width, the grooves extending in the longitudinal direction.

In some embodiments, a material of the at least one slab has a heat capacity of at least 500 J/kg*K.

In some embodiments, the at least one slab is made of silicon carbide.

In some embodiments, the frame is made of stainless steel.

In some embodiments, the heat absorbing layer is made of a material having a coefficient of thermal dilatation of less than 5*10-6%/K, an oxidation resistance of less than 1% of a weight variation at 950 degrees Celsius, a cold crushing strength of at least 150 MPa, a thermal conductivity of at least 120 W/m*K at 20 degrees Celsius, and a hardness of at least 1000 Kg/mm2.

In some embodiments, the heat diffusing layer includes a plurality of beams made of a second material having a thermal conductivity of at least 100 W/m*K.

In some embodiments, the plurality of beams are disposed one adjacent to the other to define a substantially continuous contact surface between the heat absorbing layer and the plurality of beams.

In some embodiments, the plurality of beams are I-shaped beams.

In some embodiments, the plurality of beams are secured to the frame via pins protruding from the frame and received within apertures defined through flanges of the plurality of beams.

In some embodiments, the apertures are greater than the pins to allow thermal growth of the plurality of beams.

In some embodiments, the heat diffusing layer is made of a material having a thermal capacity of at least 350 J/Kg*K, a thermal conductivity of at least 100 W/m*K, and a fusion temperature of at least 600 degrees Celsius.

In some embodiments, the heat diffusing layer is made of aluminum.

In some embodiments, the heat diffusing layer and the heat absorbing layer are different portions of a plurality of beams.

In some embodiments, the heat diffusing layer and the heat absorbing layer are different portions of a plurality of beam assemblies.

In some embodiments, each of the plurality of beam assemblies include a central beam and lateral beams, the central beam having a flange in contact with the heat absorbing layer and a web, the lateral beams disposed in contact with opposite sides of the web.

In some embodiments, the central beam is T-shaped.

In some embodiments, the central beam is made of cast iron and wherein the lateral beams are made of aluminum.

In some embodiments, the heat diffusing layer is part of the frame, the heat absorbing layer disposed over the frame.

In another aspect, there is provided an anode cooling table for supporting hot spent anodes during cooling, comprising: a frame; a plurality of heat-conducting slabs secured to the frame, the plurality of heat-conducting slabs made of a material having a heat capacity of at least 500 J/kg*K, the heat-conducting slabs extending from top faces for contacting the anodes to bottom faces opposed to the top faces and oriented toward the frame; and a heat-transfer path extending from the top faces to an environment around the anode cooling table by conduction through a heat absorbing layer and by convection and/or radiation to the environment via a heat diffusing layer in heat exchange relationship with the heat absorbing layer.

The cooling table described above may include any of the following features, in any combinations.

In some embodiments, the heat absorbing layer is defined by a first portion of the plurality of heat-conducting slabs extending from the top face towards the bottom face, the heat diffusing layer defined by a second portion of the plurality of heat-conducting slabs extending from the bottom face towards the top face.

In some embodiments, each of the plurality of heat-conducting slabs has peripheral faces extending from the top faces to the bottom faces and chamfers at intersections between the top faces and the peripheral faces, cleats in abutment against the chamfers and fasteners extending through the cleats and threadingly engaged to the frame.

In some embodiments, the anode cooling table has expansion joints disposed between each two adjacent ones of the plurality of heat-conducting slabs, the expansion joints resiliently deformable in a direction parallel to the top faces of the plurality of heat-conducting slabs.

In some embodiments, the anode cooling table has biasing members disposed between the plurality of heat-conducting slabs and the frame, the plurality of heat-conducting slabs movable in a vertical direction normal to the plurality of heat-conducting slabs by resilient deformation of the biasing members.

In some embodiments, the frame has a length in a longitudinal direction and a width in a transverse direction, the length greater than the width, the bottom faces of the plurality of slabs defining grooves extending in the longitudinal direction.

Many further features and combinations thereof concerning the present improvements will appear to those skilled in the art following a reading of the instant disclosure.

### DESCRIPTION OF THE DRAWINGS

FIG. 1 is a three dimensional view of a cooling table in accordance with one embodiment;

FIG. 2 is a three dimensional view of a frame of the cooling table of FIG. 1 in accordance with one embodiment;

FIG. 3 is a three dimensional view of a top layer of the cooling table of FIG. 1 in accordance with one embodiment;

FIG. 4 is a three dimensional cutaway view of a portion of the table of FIG. 1;

FIG. 5 is a three dimensional exploded view of a portion of the table of FIG. 1;

FIG. 6 is a three dimensional cutaway view illustrating a fastener for the table of FIG. 1;

FIG. 7 is a three dimensional enlarged view of a portion of the table of FIG. 1;

FIG. 8 is a three dimensional enlarged view of another portion of the table of FIG. 1;

FIG. 9 is a three dimensional view of a cooling table in accordance with another embodiment;

FIG. 10 is a three dimensional view of a beam of a top layer of the table of FIG. 9;

FIG. 11 is a three dimensional view of a cooling table in accordance with another embodiment;

FIG. 12 is a three dimensional view of a beam of a top layer of the table of FIG. 11;

FIG. 13 is a three dimensional view of a cooling table in accordance with another embodiment;

FIG. 14 is a three dimensional view of the cooling table of FIG. 13 with some parts removed for illustration purposes;

FIG. 15 is a three dimensional view illustrating a securing arrangement of slabs of the cooling table of FIG. 13;

FIG. 16 is an enlarged view of zone A of FIG. 14;

FIG. 17 is an enlarged view of zone B on FIG. 14;

FIG. 18 is an enlarged view of zone C on FIG. 13;

FIG. 19 is an enlarged view of zone D on FIG. 14;

FIG. 20 is a three dimensional top view of one of the slabs of the cooling table of FIG. 13;

FIG. 21 is a three dimensional bottom view of the slab of FIG. 20; and

FIG. 22 is a schematic view illustrating heat-transfer paths from the anodes to an environment.

### DETAILED DESCRIPTION

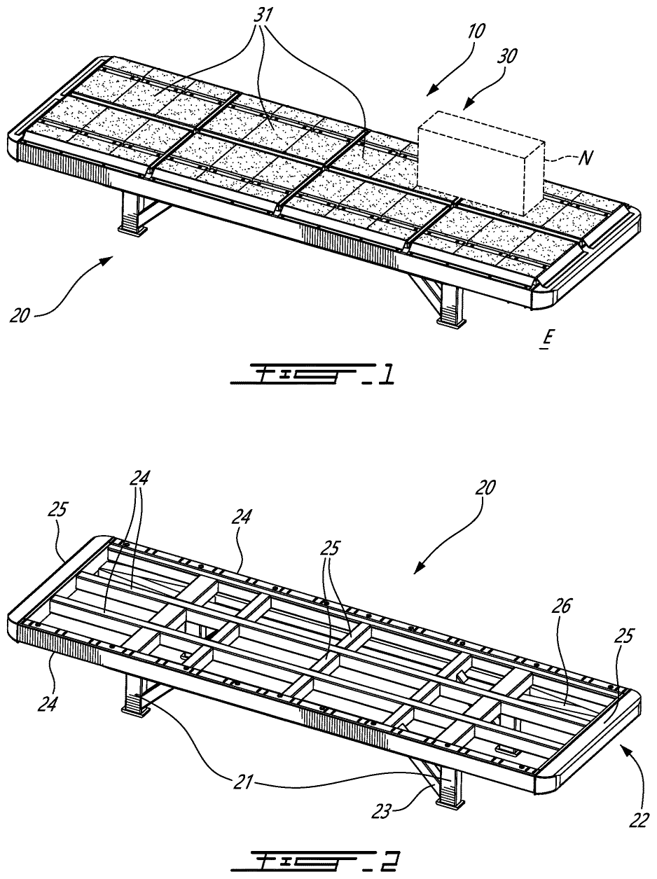

Referring to FIG. 1, an exemplary cooling table is shown at 10. The cooling table 10 is used to receive and support the hot spent anodes, simply “anodes N” below, after they are taken out of the electrolysis cell. The cooling table 10 may increase a heat transfer between the spent anodes and an environment E surrounding the cooling table 10 and the spent anodes. This may decrease a cooling time of the spent anodes and, therefore, may diminish the amount of HF that is generated by the spent anodes.

The cooling table 10 is designed with many constraints. First, the cooling table 10 should not require cell-operating personnel to alter their routine tasks to avoid inducing unnecessary delays. Second, the cooling table 10 should not require any modifications of other equipment of an aluminum smelting facility. Moreover, the total weight of the cooling table 10 should not exceed 4000 kg in some embodiments; it may have to be movable using a heavy duty vehicle; it may have to be sized to be transportable within the smelting facility and between smelting facilities.

The cooling table 10 is used to circulate in loop during the smelting process. New or spent anodes, eight in the present embodiment, are laid on the cooling table 10; the cooling table 10 is moved to a storage facility before being transported to the smelting facility by loading two of the cooling tables 10 on a dedicated transporter, more or less tables may be transported at once in some other embodiments; at the facility, the cooling table 10 are unloaded and moved to a storage facility before being transported for production; the new anodes are substituted for the spent anodes; the spent anodes are loaded on the cooling table 10; the cooling table 10 and the spent anodes are transported to a storage facility for cooling; the cooling table 10 and the spent anodes are then transported to another facility once sufficiently cooled, unloaded from the cooling table 10; and the cooling table 10 is cleaned and ready to start the cycle over.

Previous tables were designed to simply support the spent anodes during their cooling down phase and to minimize heat transfer between the spent anodes and the tables in order to avoid excessive thermal stress on tables The disclosed cooling table 10 follows an opposite philosophy in that a heat transfer between the spent anodes and the cooling table 10 is maximized as will be disclosed below. This may be done by selecting appropriate material and assembly techniques to simultaneously increase heat transfer while maintaining reliability of the cooling table 10.

Still referring to FIG. 1, the cooling table 10 generally includes a frame 20 and a top layer 30, which may also be referred to as a heat transfer layer, supported by the frame 20. The heat transfer layer 30 is used to pick up heat from the spent anodes and transfer that heat to the environment E via the frame 20 or directly via convection and/or radiation. The frame 20 is described first using reference numerals in the 20's and the top layer 30 is then described with reference numerals in the 30's.

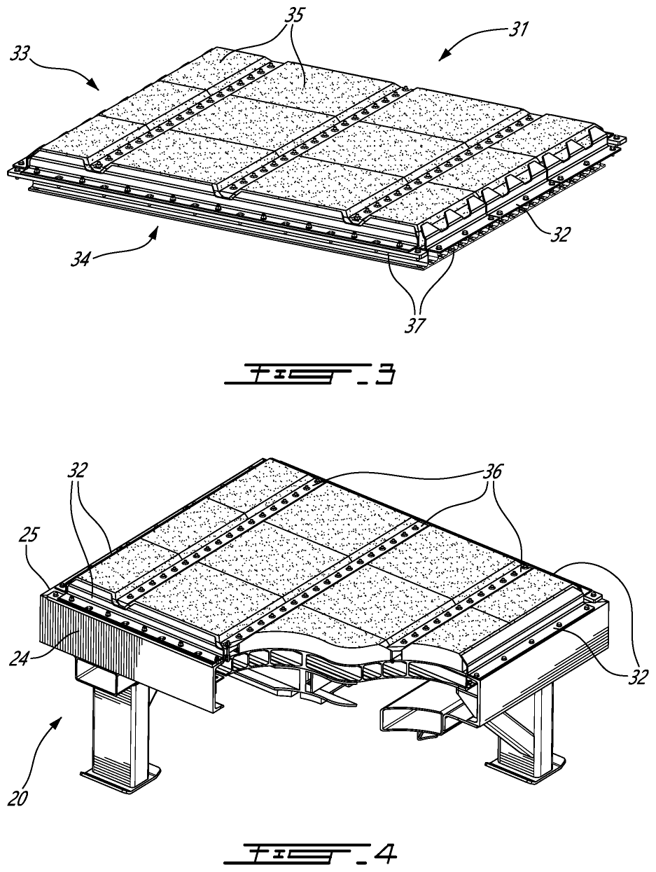

Referring to FIG. 2, the frame 20 includes legs 21, four in the embodiment shown but more or less is contemplated, that support a table top 22. Bracing members 23 may be used to strengthen a connection between the legs 21 and the table top 22, but they may be omitted in some embodiments. The table top 22 includes longitudinal members 24 and transversal members 25 that intersect one another to define a grid. Bracing members 26 may be used to strengthen connections between the longitudinal members 24 and the transversal members 25, but they may be omitted in some embodiments. The longitudinal members 24 and the transversal members 25 may be tubular member of a substantially rectangular cross-section. However, other shapes are contemplated and any suitable members may be used without departing from the scope of the present disclosure.

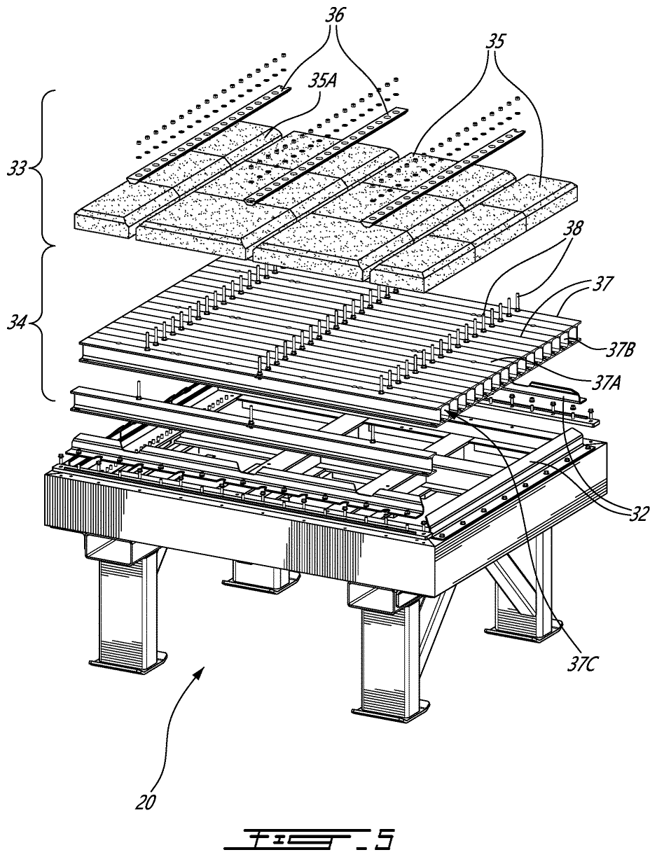

Referring now to FIGS. 3-5, the top layer 30 includes a plurality of table top assemblies 31 mounted to the frame 20. FIGS. 3-5 illustrate a single one of these table top assemblies 31. The below description may therefore apply to all of the table top assemblies 31. Each of the table top assemblies 31 may be sized to receive a corresponding anode for cooling. The table top assemblies 31 are supported on the table top 22 of the frame 20 and may be held in place using cleats 32. These cleats 32 may be secured to the longitudinal members 24 and to the transversal members 25 of the frame 20. The cleats 32 may be angled such as to define an abutment face to maintain a position of the table top assemblies 31 in directions parallel to the table top (e.g., longitudinal and transversal directions) and to maintain a vertical position of the table top assemblies 31. The cleats 32 may be fastened to table top 22 of the frame 20. In some embodiments, the cleats 32 allow to maintain the silicon carbide blocks without piercing through them and permitting their thermal expansion and/or slight movement.

Referring more particularly to FIG. 5, the table top assemblies 31 include a heat absorbing layer 33 and a heat diffusing layer 34. In some other embodiments, the heat absorbing layer 33 may be a part of the frame 20. In other words, the frame 20 may comprise the heat diffusing layer 34 and the heat absorbing layer 33 may be disposed over the frame 20. The heat diffusing layer 34 is located between the table top 22 of the frame 20 and the heat absorbing layer 33. The heat absorbing layer 33 is configured to contact the spent anodes during their cooling after they have been taken out of the electrolysis cell-pot and is used to transfer heat from the spent anodes to the heat diffusing layer 34, which may be responsible for diffusing the heat to the frame 20 and environment E. The heat absorbing layer 33 is in heat exchange relationship with the frame 20 through the heat diffusing layer 34.

The heat absorbing layer 33 defines a substantially continuous surface against which the spent anodes are laid on after they have been taken out of the aluminum reduction cell. Herein, the expression “substantially continuous” means that a surface of contact is created between the heat absorbing layer 33 and the spent anodes. By being “substantially continuous”, an area of the surface of contact between the spent anodes and the heat absorbing layer 33 may substantially correspond to an area of a face of the spent anode that is in contact with the heat absorbing layer 33. It will be appreciated that the area of the surface of contact between the spent anodes and the heat absorbing layer 33 may be more than half, preferably more than 80%, preferably more than 90% of the area of the face of the spent anode that is in contact with the heat absorbing layer 33. The difference between the areas may result from gaps defined between the elements (e.g., beams, slabs, etc) that define the heat absorbing layer 33.

The heat diffusing layer 34 is used to transfer heat from the heat absorbing layer 33 to the frame 20 and to an environment surrounding the frame 20. Again, a substantially continuous surface of contact may be defined between the heat absorbing layer 33 and the heat diffusing layer 34 to maximize heat transfer from the heat absorbing layer 33 to the frame 20 via the heat diffusing layer 34.

Still referring to FIG. 5, the heat absorbing layer 33 of each of the table top assemblies 31 includes a plurality of slabs 35 laid on top of the heat diffusing layer 34. In the present embodiment, each table top assembly 31 includes four slabs 35, two having a smaller width than that of the other two, but any number of slabs 35 is contemplated. In some embodiments, a single slab may be used. In some other embodiments, a matrix of slabs (e.g., 2×2) may be used. The number of slabs 35 is minimized to maximize an area of contact with the anodes. In the embodiment shown, the slabs 35 are made of silicon carbide, but other materials are contemplated. For instance, the slabs 35 may be made of cast iron. Any material that has a high heat capacity, a high thermal mass, and a suitable resistance to impacts is contemplated since the slabs 35 may be hit with the anodes as they are laid on the cooling table 10. The heat capacity of the material of the slabs 35 may be above 500 J/kg*K, preferably above 600 J/kg*K. In some cases, the heat capacity of the material of the slabs 35 is about 750 J/kg*K. The material selected for the slabs 35 should have a high thermal conductivity to minimize thermal gradients within it, a low coefficient of thermal dilatation, resistance to oxidation, a high cold crushing strength, and a good thermal conductivity. In some embodiments, the material of the slabs 35 has a coefficient of thermal dilatation of from about 4*10⁻⁶ to about 4.6*10⁻⁶%/K, preferably less than 5*10⁻⁶%/K. The oxidation resistance for the material of the slabs 35 may be less than 1%, preferably from about 0.5% to about 0.65%, of a weight variation at 950 degrees Celsius. The cold crushing strength of the material of the slabs 35 may be greater than 150 MPa, preferably from about 180 MPa to about 220 MPa. The thermal conductivity of the material of the slabs 35 may be about 120 W/m*K at 20 degrees Celsius, preferably between 60 and 150 W/m*K. In some embodiments, cast iron may be used as the material of the slabs 35. A hardness of the material of the slabs 35 may be at least 1000 Kg/mm², preferably at least 2800 Kg/mm².

In the embodiment shown, the slabs 35 have beveled edges 35A, but this need not be the case and other shapes for the slabs 35 are contemplated. The beveled edges 35A are abutted by the cleats 32 for retention of the table top assemblies 31 to the frame 20. The slabs 35 may have a thickness of about 60 mm, a width of from 237.5 to 475 mm, and a length of about 400 mm. Herein, the expression about encompasses variations of plus or minus 10%.

As shown in FIG. 5, wedges 36 are received between each two adjacent ones of the slabs 35 and are sized to abut against the beveled edges 35A. The wedges 36 are fastened to the heat diffusing layer 34 and, thanks to the cooperating angled or beveled faces of the wedges 36 and of the slabs 35, the wedges 36 hold the slabs 35 against the table top 22 of the frame 20 to prevent vertical displacement of the slabs 35. The wedges 36 may be made of stainless steel or any other suitable material. The wedges 36 may be recessed below a top face of the slabs 35 such that the wedges 36 may not in contact with the anodes.

The heat diffusing layer 34 includes a plurality of beams 37. In the present case, fifteen beams 37 are used, but any suitable number of beams 37 is contemplated. The beams 37 have, in the present embodiment, an “I” cross-section that defines two flanges 37A secured to a web 37B. The flanges 37A at the top of the beams 37 are in contact with the slabs 35 to maximize a heat transfer between the slabs 35 and the beams 37. The flanges 37A at the bottom of the beams 37 are in contact with the table top 22 to maximize a heat transfer between the beams 37 and the frame 20. The beams 37 may have different cross-sectional shapes. The beams 37 may have a length of about 950 mm. The width and height of the beams 37 may be about 76.2 mm (3 inches). A thickness of the two flanges 37A and of the web 37B may be about 6.35 mm (0.25 inch). It will be appreciated that those dimensions are exemplary only.

In the embodiment shown, the beams 37 and the slabs 35 are transverse to one another. This may ensure that a gap between two adjacent ones of the slabs 35 does not register with an intersection between two adjacent ones of the beams 37. However, other arrangements are contemplated. For instance, the beams 37 and the slabs 35 may be parallel to one another and may be angled (e.g., 45 degrees) to one another without departing from the scope of the present disclosure.

The beams 37 may be made of any material having high thermal conductivity. The thermal conductivity of the material of the beams 37 may be above 100 W/m*K, preferably above 200 W/m*K. In the present case, the beams 37 are made of aluminum, but may be made of copper, steel, stainless steel, brass, an allow of aluminum and copper, bronze, cast iron, chromium, graphite, and/or iron, in other variants. The material of the beams 37 is selected to minimize deformation when the anodes are laid on the cooling table 10. The material of the beams 37 may have thermal capacity of at least 350 J/Kg*K, preferably at least 500 J/Kg*K and a thermal conductivity of at least 100 W/m*K. A fusion temperature of the material of the beams 37 is preferably above 600 degrees Celsius.

In the illustrated embodiment, the beams 37 are in contact with one another. This may further help the heat transfer from the slabs 35 to the frame 20 by maximizing an area of contact between the slabs 35 and the beams 37. Moreover, heat diffusion across the beams 37 may be enhanced by having the beams 37 in abutment against one another. In one variant, the beams 37 may be spaced apart to allow air from cooling down the slabs 35 by natural convection. The beams 37 may further define channels 37C between the webs 37B. These channels 37C may allow cooling by natural convection. The beams 37 are in contact with the longitudinal members 24 and with the transversal members 25 of the frame 20 such that heat from the anodes is transferred to the slabs 35, from the slabs 35 to the beams 37, from the beams 37 to the members of the frames 20, and to the environment surrounding the cooling table 10. It will be appreciated that heat may also be transferred in parallel from each of the anodes, the slabs 35, the beams 37, and the frame 20 to the environment via natural convection.

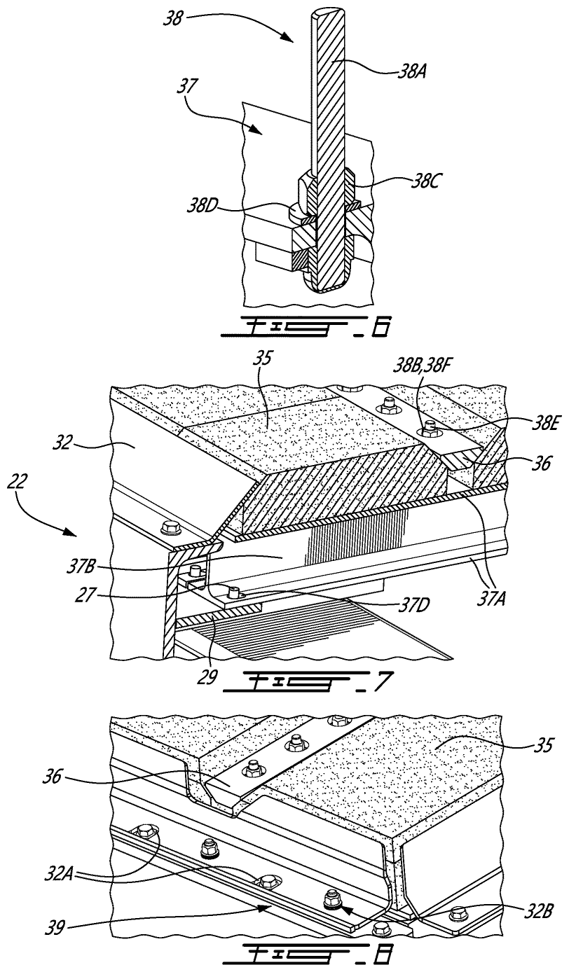

Referring now to FIGS. 5-7, in the embodiment shown, each of the beams 37 is fastened to the wedges 36 via fasteners 38. One of the fasteners 38 is shown in FIG. 6. The fasteners 38 each include a threaded shank 38A and head 38B, which may be hexagonal. A first nut 38C is threadingly engaged on the threaded shank 38A and a first washer 38D is disposed around the threaded shank 38A and between the first nut 38C and the beam 37. The first washer 38D may alternatively be located between the head 38B and the beams 37. The threaded shank 38A is sized to be received through correspondingly sized apertures defined through the wedges 36 and a second nut 38E is threadingly engaged to the threaded shank 38A. A second washer 38F is disposed between the wedge 36 and the second nut 38E. The first washer 38D and the second washer 38F may be resiliently deformable washers, such as Belleville washers, that are deformable in a direction parallel to the threaded shank 38A. These washers may allow some relative movements between the parts caused by thermal expansion. Hence, the washers may accommodate thermal growth of the slabs 35 and/or of the beams 37 when the hot spent anodes are laid against the slabs 35. Moreover, the washers may allow the wedges 36 to move vertically in relation to the slabs 35 with thermal growth. The cooperation of the wedges 36 and the washers may ensure proper retention of the slabs 35 regardless of their temperature.

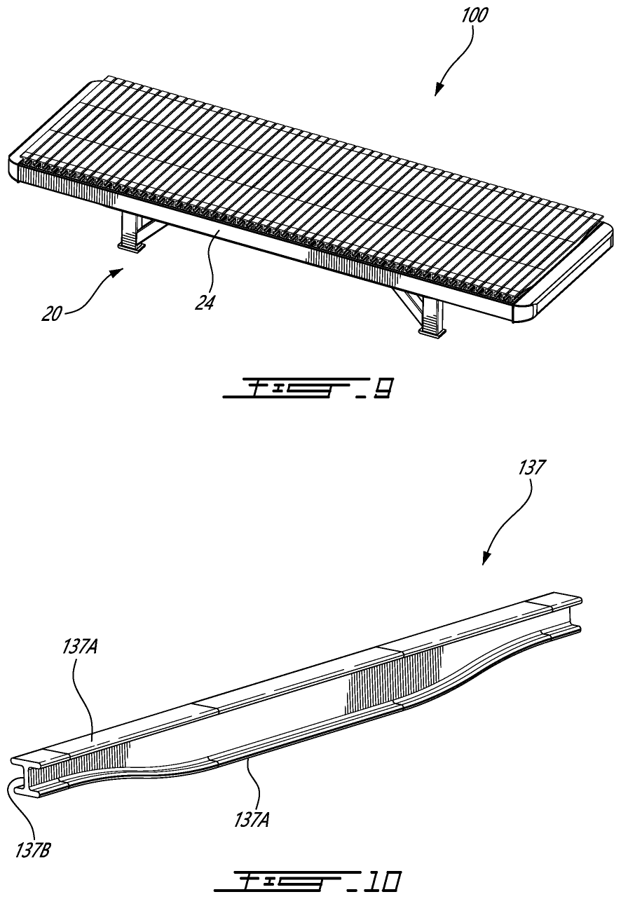

Referring more particularly to FIG. 7, in the embodiment shown, the heat diffusing layer 34, which includes the beams 37, is recessed below a top surface of the table top 22. The frame 20 defines a flange 29 against which the table top assemblies 31 rest. In the present case, the extremities of the beams 37 are abutted against the flange 29 of the table top 22. The beams 37 may define apertures 37D sized to accept pins 27 located on the table top 22. The pins 27 may protrude substantially vertically from the flange 29. The pins 27 may help in locating and maintaining a position of the beams 37 in relation to the frame 20. The apertures 37D may be oversized to allow thermal growth of the beams 37 and to avoid thermal constraints that might otherwise occur between the beams 37 and the frame 20. The apertures 37D may be have an elongated shape.

Referring more particularly to FIG. 8, the cleats 32, which may be made of stainless steel or other suitable material, are fastened to the frame 20. Some of the cleats 32 are fastened to the frame 20 via an intermediary plate 39, which may be made of stainless steel or any other suitable material. These cleats define apertures, which may be elongated, sized to accept shanks of fasteners used to secure the cleats 32 to the frame 20. The intermediary plate 39 is fastened to the frame 20 and the cleats 32 may define oblong aperture 32A to accept heads of the fasteners used to secure the intermediary plate 39 to the frame 20. The oblong aperture 32A, thanks to their elongated shape, may allow adjustment of a position of the cleats 32 in relation to the frame 20 to snugly hold the slabs 35. Washers 32B, which may be Belleville washers, are used to allow relative movement of the cleats 32 caused by thermal growth. The cleats 32 are angled to abut the beveled edges of the slabs 35 to provide vertical retention of the slabs 35 relative to the frame 20 as discussed above.

The disclosed cooling table 10 may reduce the cooling time of the spent anodes from 12 hours to 9 hours (below 150 degrees Celsius). The disclosed cooling table 10 may reduce the emission of HF by at least 30% and up to 50% in some cases. This decrease in HF emission that may be allowed by the cooling table 10 may allow the increase of the production of the aluminum smelting facility without exceeding HF emission limits set by some regulations. The disclosed cooling table 10 may be used for other purposes. For instance, it may be used to cool down any other hot matter. It may be used to cool down the electrolyte bath.

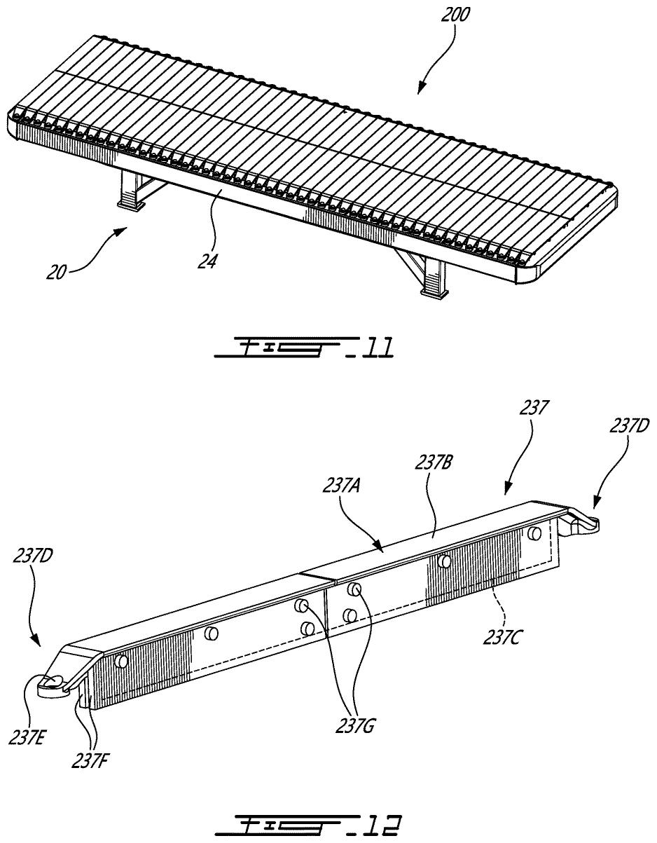

Referring now to FIGS. 9-10, another embodiment of a cooling table is shown at 100. The cooling table 100 includes the frame 20 described herein above with reference to FIG. 2. In the embodiment shown, the cooling table 100 includes beams 137 that are made of cast iron. Any other suitable material having a high heat capacity and a high thermal mass is contemplated. The beams 137 may be made of steel, and so on. The beams 137 extend transversally to the longitudinal members 24 of the frame 20. Alternatively, they may extend parallel to the longitudinal members 24. The beams 137 have, in the present embodiment, an “I” cross-section that defines two flanges 137A secured to a web 137B. Top flanges of the flanges 137A are used to define a substantially continuous surface for contacting the anodes during cooling. Bottom flanges of the flanges 137A are used to contact the frame 20 to transfer heat to the frame and to the environment surrounding the cooling table 100.

Each of the beams 137 may have a height that is greater at its center than at its extremities. The height is the distance between the two flanges 137A. The increased height at the center may help in absorbing more heat from the anodes and may strength the beams 137, which are designed to support the weight of these anodes/spent anodes. A top one of the two flanges 137A defines a surface against which the anodes are laid. As shown in FIG. 9, the beams 137 are disposed in close proximity to one another and may contact each other. This may maximise a contact surface area between the anodes and the central beam 237A.

In the present embodiment, the top flanges of the flanges 137A and a portion of the webs 137B define the heat absorbing layer whereas a remainder of the webs 137B and the bottom flanges of the flanges 137A may define the heat diffusing layer. Hence, the two layers may be part of the same monolithic beams.

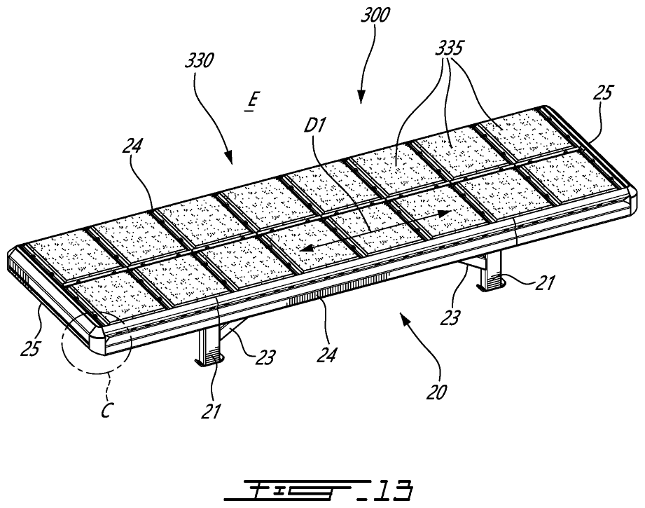

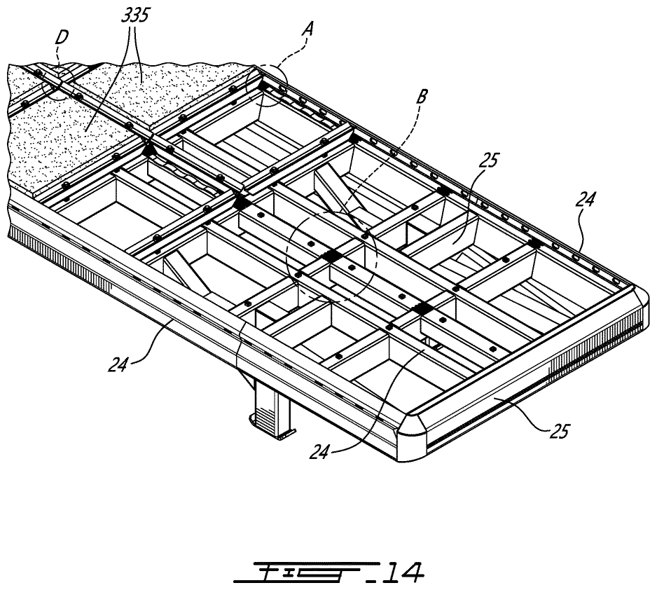

Referring now to FIGS. 11-12, another embodiment of a cooling table is shown at 200. The cooling table 200 includes the frame 20 described herein above with reference to FIG. 2. In the embodiment shown, the cooling table 200 includes beam assemblies 237. The beam assemblies 237 extend transversally to the longitudinal members 24 of the frame 20. Alternatively, they may extend parallel to the longitudinal members 24. The beam assemblies 237 include a central beam 237A that may have a “T” cross-section. The central beam 237A has a flange 237B and a web 237C extending from the flange 237B. The central beam 237A may be made of cast iron. Any other suitable material having a high heat capacity and a high thermal mass is contemplated. The central beam 237A may be made of steel, and so on. The central beam 237A has end portions 237D that slope towards the frame 20 and that define aperture 237E sized to accept fasteners used to secure the beam assemblies 237 to the frame 20. The flanges 237B of the central beams 237A are used to define a substantially continuous surface for contacting the spent anodes during cooling.

The beam assemblies 237 include two lateral beams 237F that are disposed on opposite sides of the web 237C of the central beam 237A. The lateral beams 237F are used to contact the frame 20 to transfer heat to the frame 20 and to the environment surrounding the cooling table 200. The two lateral beams 237F may be fastened to the web 237C of the central beam 237A using rivets 237G, bolts, or any other suitable fasteners. They may be welded to the central beam 237A in one embodiment. The two lateral beams 237F may be made of aluminum, copper, or any other suitable material having a high thermal conductivity. The thermal conductivity of the material of the lateral beams 237F may be above 100 W/m*K, preferably above 200 W/m*K.

The central beam 237A, more specifically the flange 237B, defines a surface against which the anodes/spent anodes are laid on. The central beam 237A therefore transmits the heat it receives from the anodes to the lateral beams 237F via the contact there between. The heat is then transmitted from the lateral beams 237F to the frame 20 and to the environment surrounding the cooling table 200. In the present embodiment, the flanges 237B of the central beams 237A and a portion of the webs 237C define the heat absorbing layer whereas a remainder of the webs 237C and the lateral beams 237F define the heat diffusing layer.

In some embodiments, heat pipes may be attached to the beams 37, 137, 237 to help dissipating the heat of the anodes. In some other embodiments, a material being flexible may be used to decrease a contact thermal resistance with the anodes. In other words, material may be flexible enough to conform to a shape of the anodes once they are laid on the cooling table 10, 100, 200. Springs may be used for this purpose.

In the embodiments described in FIGS. 1-12, a heat-transfer path between the anodes N and the environment E extends from the top faces of the slabs 35 to the environment E by conduction through the heat absorbing layer 33 and by convection and/or radiation to the environment E via the heat diffusing layer 34 in heat exchange relationship with the heat absorbing layer 33.

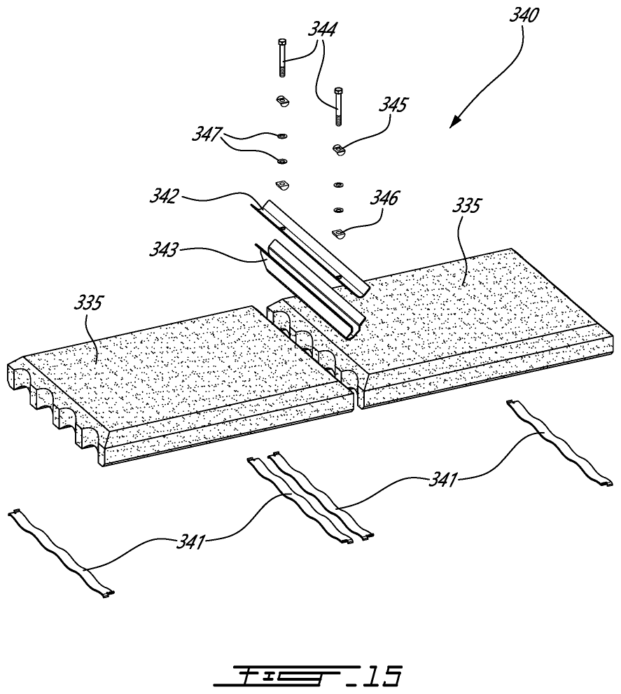

Referring now to FIGS. 13-14, another embodiment of a cooling table is shown at 300. For the sake of conciseness, only features differing from the cooling table 10 described above with reference to FIGS. 1-12 are described below.

The cooling table 300 includes a frame 20, which is described above with reference to FIG. 2. The frame 20 supports a top layer 330 that is used to absorb heat from the anode and to transfer this heat to the environment E, either directly via convection and/or radiation, and/or indirectly via conduction to the frame 20. From the frame 20, the heat may be dissipated to the environment by convection and/or radiation.

The cooling table 300 includes a plurality of slabs 335 disposed over the frame 20. As explained above, these slabs 335 are used to absorb heat from the anodes N via conduction and to transfer this heat to the environment E, either directly and/or via the frame 20. The cooling table 300 has a securing arrangement 340 (FIG. 15) to mount the slabs 335 to the frame 20. The slabs 335 may be bigger than the slabs 35 of the cooling table 10 described with reference to FIGS. 1-12 to minimize the number of gaps between the slabs 335. This may effectively maximize an area of contact between the anodes N and the slabs 335 and, thus, improve heat transfer.

Referring now to FIG. 15, the securing arrangement 340 is now described. In the present embodiment, the securing arrangement 340 includes biasing members 341 for supporting the slabs 335. The biasing members 341 are herein linear wave springs that may be seen as undulated plates having a series of crests and valleys distributed in alternation along their lengths. Any other suitable means for resiliently supporting the slabs 335, such as leaf springs, coil springs to name a few, are contemplated. The biasing members 341 may be high temperature flexible polymer members. The biasing members 341 may provide shock resistance, a high vertical load capability, abrasion resistance, and flexibility. The biasing members 341 are disposed between the slabs 335 and the frame 20. More specifically, the biasing members 341 may be in abutment against peripheries of the slabs 335 and against the longitudinal members 24 and the transverse members 25 of the frame 20. These biasing members 341 may be used to absorb vertical motions of the slabs 335, either caused by the weight of the anode deposited thereon and/or caused by thermal expansion/contraction of the different parts of the cooling table 300. The biasing members 341 may cater to imperfections of the frame 20 of the cooling table 300 and may allow thermal expansion of the slabs 335. The biasing members 341 are preferably made of steel, but any other suitable material may be used. The biasing members 341 may be elastically deformable/compressible in a vertical direction perpendicular to the top faces 335A of the slabs 335. In other words, the plurality of slabs 335 are movable in the vertical direction by resilient deformation of the biasing members 341. Furthermore, the biasing members 341 are used to transfer heat via conduction from the slabs 335 to the frame 20. In other words, the slabs 335 may be in heat exchange relationship with the frame 20 at least partially by conduction via the biasing members 341.

The securing arrangement 340 further includes cleats 342, herein provided as elongated V-shaped members, disposed between each two adjacent ones of the slabs 335. These cleats 342 are sized to abut the peripheries of the slabs 335, which may be chamfered, to limit vertical movements of the slabs 335 away from the frame 20. Expansion joints 343 may also be disposed between each two adjacent ones of the slabs 335 to cater to thermal expansion and contraction of the slabs 335 and/or of the frame 20 of the cooling table 300. The expansion joints 343 are resiliently deformable in a direction parallel to the top faces 335A of the slabs 335. These expansion joints 343 may be aligned with the cleats 342. The expansion joints 343 may be elongated U-shaped or V-shaped members with a flared top opening sized to accept the cleats 342. In other words, the cleats 342 may be at least partially received within cavities defined by the expansion joints 343.

The cleats 342 and the expansion joints 343 may be secured to the frame 20 via fasteners 344. These fasteners 344 may be threadingly engaged to the frame 20. Locking members 345 may be used to prevent loosening of the fasteners 344. Centering wedges 346 may be disposed between heads of the fasteners 344 and the cleats 342. These centering wedges 346 may be used to center the cleats 342 between the two adjacent slabs 335 and to improve a pressure distribution from the heads of the fasteners 344 on the cleats 342 since a shape of the heads of the fastener 344 may be different than that of the cleats 342. In other words, the centering wedges 346 may create an interface between the fasteners 344 and the cleats 342. Then, biasing washers 347, such as Belleville™ washers, may be disposed between the heads of the fasteners 344 and the cleats 342. These biasing washers 347 may be used to cater to thermal expansion and/or contraction of the slabs 335 during use. In some embodiments, the biasing washers 347, the centering wedges 346, and the locking members 345 may be replaced by similar components or omitted in some embodiments.

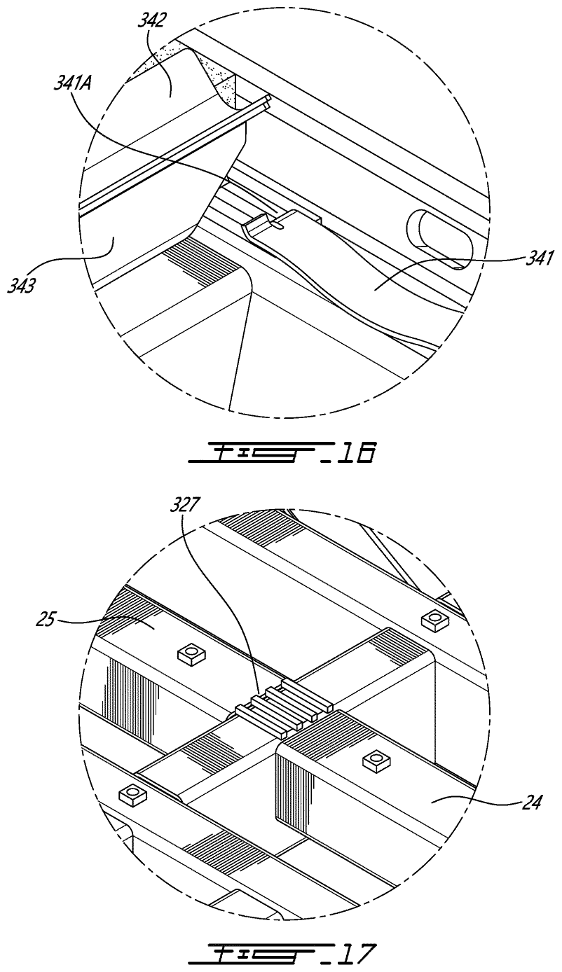

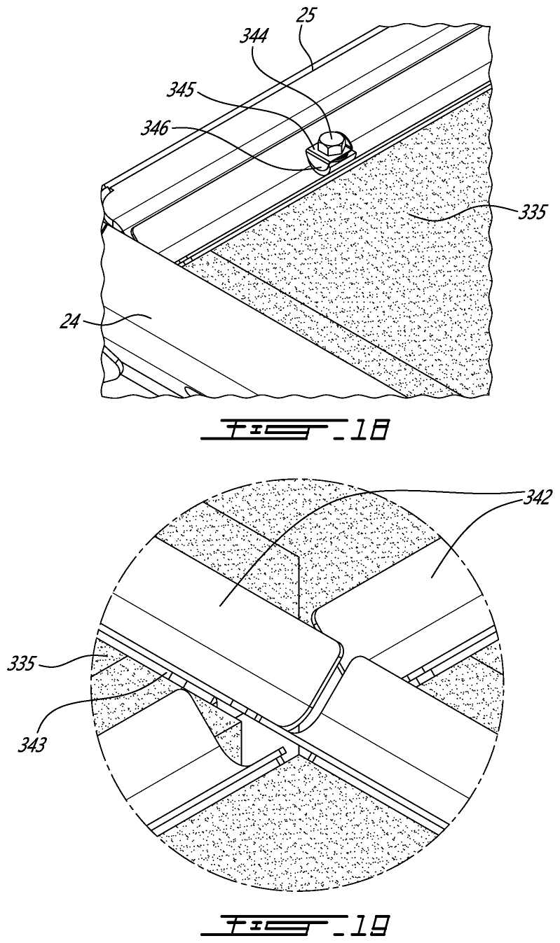

Referring now to FIGS. 16-17, enlarged views of zones A and B of FIG. 14, respectively, are presented. In the embodiment shown, the frame 20 defines locking keys 327, which may be located at intersections between the longitudinal and transverse members 24, 25, or at any suitable locations. These locking keys 327 are engageable by hooks 341A defined at ends of the biasing members 341. A locking engagement is thus created between the locking keys 327 and the biasing members 341 to limit movements of the biasing members 341 in relationship to the frame 20 in a longitudinal or transverse directions being both parallel to a top surface of the frame 20.

Referring to FIG. 18, an enlarged view of zone C of FIG. 14 is presented. According to some embodiments, the fasteners 344, the locking members 345, and the centering wedges 346 may be protected by the frame 20. In other words, the fasteners 344 are disposed inwardly of the longitudinal and transverse members 24, 25 of the frame and may sit below a top face of the slabs 335. Thus, the fasteners 344 may be substantially protected against impact from the anodes N by being shielded on one side by the frame 20 and on the other side by the slabs 335. Furthermore, by being at an elevation lower than the top face of the slabs 335, the fasteners 344, which may thus be recessed from a top surface defined by the slabs 335, are less likely to be impacted by the anodes A.

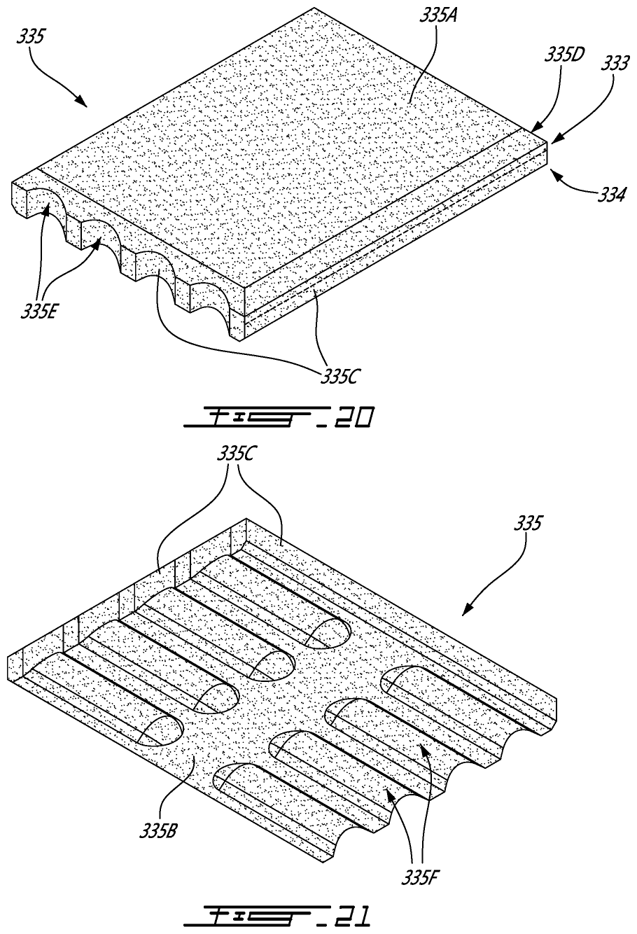

Referring now to FIG. 19, an enlarged view of zone D of FIG. 14 is presented. The cleats 342 substantially overlap the expansion joints 343. Thus, the cavities defined by these expansion joints 343 may be covered by the cleats 342. This may limit debris or other matter from accumulating within the cavities of the expansion joints 343. Periodic cleaning of the cooling table 300 may therefore be avoided or, simply, be carried at a lower frequency. This may reduce down time and increase efficiency.

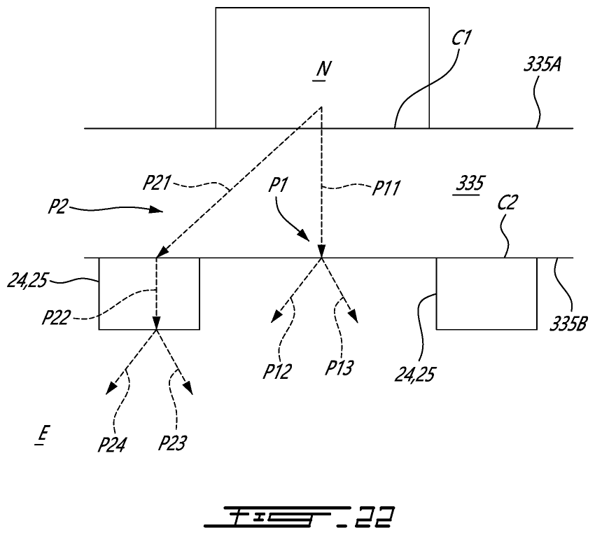

Referring now to FIGS. 20-21, the slabs 335 are described in more details. The below description uses the singular form, but may apply to each of the slabs 335. The slab 335 may be square or rectangular in shape. Other shapes are contemplated. The slab 335 has a top face 335A, an opposed bottom face 335B, and peripheral faces 335C extending from the top face 335A to the bottom face 335B. A chamfer 335D is located at an intersection between the top face 335A and the peripheral faces 335C. This chamfer 335D is designed to be abutted by the cleats 342 (FIG. 15) for restraining vertical movements of the slab 335.

Two opposed ones of the peripheral faces 335C define peripheral grooves 335E that extend from the top face 335A to the bottom face 335B. The peripheral grooves 335E are used to reduce stress constraints caused by thermal loads applied on the slab 335 from the anodes A. They may be omitted in some embodiments.

The bottom face 335B of the slab 335 defines longitudinal grooves 335F, also referred to as cooling grooves. The longitudinal grooves 335F increase a surface area of the bottom face 335B to increase heat transfer via convection with ambient air. The longitudinal grooves 335F may further increase air flow under the frame 20. The longitudinal grooves 335F extend in a longitudinal direction D1 (FIG. 13) that is parallel to a length of the cooling table 300 that is greater than a width of the cooling table 300. Each of the longitudinal grooves 335F extends from one of two opposed ones of the peripheral faces 335C towards a center of the slab 335. In other words, the longitudinal grooves 335F may not extend a complete length of the slab 335. A central portion of the bottom face 335B of the slab 335 may be free of grooves 335F. The longitudinal grooves 335F may increase a surface area of the slab 335 that transfers heat to the environment via convection, increase heat transfer via natural convection, and may reduce a weight of the slab 335. Moreover, as mentioned above, the grooves 335F may increase an air flow under the frame 20. This may, in turn, increase a heat transfer from the slabs 335 to the environment E via natural convection. The shape of the longitudinal grooves 335F may result in a maximized cooling of the slab 335 via conduction, conduction, and radiation. In some embodiments, the longitudinal grooves 335F may be omitted.

As shown in FIG. 20, the slabs 335 may therefore define both of a heat absorbing layer 333 extending from the top face 335A towards the bottom face 335B and a heat diffusing layer 334 extending from the bottom face 335B to the top face 335A. In other words, the slabs 335 may have top sections in contact with the anodes N and absorbing heat from the anodes N and bottom sections in heat exchange relationship with the top sections, herein via conduction, and used to transfer heat to the environment E, either directly via convection and radiation, or via the frame 20 via conduction. Thus, a plane substantially parallel to the top face 335A may define a boundary between the heat absorbing layer 333 of the slabs 335 and the heat diffusing layer 334 of the slabs 335. An imaginary separation between these two layers is shown with a dashed line in FIG. 20. In the present embodiment, the heat absorbing layer 333 and the heat diffusing layer 334 are monolithic parts of the same structure, herein, the slabs 335. In some embodiments, only the bottom faces 335B of the slabs 335 may define the heat diffusing layer 334.

The cooling table 300 may have a total mass of about 3250 kg, may include about 16 slabs 335 of silicon carbide, which may provide a total mass of about 1782 kg, may have a thermal mass of about 1337 kJ/K (without the steel), may include about 18 expansion joints in the longitudinal direction and 8 expansion joints in the transversal direction, and about 52 fasteners. Other dimensions are contemplated.

Referring now to FIG. 22, a schematic representation of how heat is being transferred from the anode N to the environment E is shown. In the embodiment shown, the heat may be extracted from the anode N to the environment E along a first heat-transfer path P1 that extends through the slabs 335 and directly to the environment E, and along a second heat-transfer path P2 that extends through the slabs 335 and through the frame 20, more specifically, through the members 24, 25 that are in contact with the slabs 335, either directly or via the biasing members 341. It will be appreciated that this representation of the different heat-transfer paths is schematic and used to denote one of possible direction of heat transfer from the anodes N to the environment E via the slabs 335 and the frame 20. In other words, the heat-transfer paths, although depicted as unidirectional across a thickness of the slabs 335 and isotropic, will, practically, be multi-directional and extends also in directions perpendicular to the thickness of the slabs 335. Thus, the representation of the heat-transfer paths of FIG. 22 is used to denote a component of heat transfer that occurs in a vertical direction, across a thickness of the slabs 335. Other components of heat transfer, in other directions, are also possible even if not represented in FIG. 22.

In the embodiment of FIG. 22, the heat-transfer path therefore extends from the top faces 335A of the slabs 335 to the environment E by conduction through the heat absorbing layer 333 and by convection and/or radiation to the environment via a heat diffusing layer 334 in heat exchange relationship with the heat absorbing layer 333. As explained above, the heat absorbing layer 333 and the heat diffusing layer 334 are two different portions of the slabs 335.

Along the first heat-transfer path P1, the heat is transferred from the anodes N to the top faces 335A of the slabs 335 via first contacts C1 between the anode N and the top faces 335A of the slabs 335. Heat is then transferred form the top faces 335A to the bottom faces 335B by conduction through the slabs 335 along a first primary sub-path P11. Once the heat reaches the bottom faces 335B, it is transferred to the environment E along a second primary sub-path P12 via convection with air of the environment E and along a third primary sub-path P13 via radiation to the environment E. The second and third primary sub-paths P12, P13 are parallel to one another. That is, heat is being transferred from the bottom faces 335B of the slabs 335 along the second and third primary sub-paths P12, P13 simultaneously. By being parallel, it is understood that heat is being transferred from the bottom faces 335B of the slabs 335 along the second and third primary sub-paths P12, P13 simultaneously.

Along the second heat-transfer path P2, the heat is transferred from the anodes N to the top faces 335A of the slabs 335 via the first contacts C1 between the anode N and the top faces 335A of the slabs 335. Heat is then transferred form the top faces 335A to the bottom faces 335B by conduction through the slabs 335 along a first secondary sub-path P21, which substantially corresponds to the first primary sub-path P11. Once the heat reaches the bottom faces 335B, it is transferred to the frame 20, and more particularly to the longitudinal and transverse members 24, 25, via second contacts C2 therebetween. It will be appreciated that the second contacts C2 may include direct contacts between the slabs 335 and the frame 20 or, alternatively, may include contacts between the slabs 335 and the biasing members 341 (FIG. 15) and contacts between the biasing members 341 and the frame 20. The heat is then transmitted through the frame 20 by conduction along a second secondary sub-path P22. Once the heat reaches the other faces of the frame 20 that are not in contact with the biasing members 341 and/or the slabs 335, the heat is transferred to the environment E along a third secondary sub-path P23 via convection with air of the environment E and along a fourth secondary sub-path P24 via radiation to the environment E. The third and fourth secondary sub-paths P23, P24 are parallel to one another. That is, heat is being transferred from the frame 20 along the third and fourth secondary sub-paths P23, P24 simultaneously.

The first and second heat-transfer paths P1, P2 are parallel to one another. That is, heat may reach the environment E via both of the first and second heat-transfer paths P1, P2 independently from one another. In other words, a first portion of heat reaches the bottom faces 335B of the slabs 335 at locations not overlapped by members of the frame 20 via the first heat-transfer paths P1 while, at the same time, a second portion of heat reaches the bottom faces 33B of the slabs 335 at locations overlapped by the members of the frame 20.

As can be seen therefore, the examples described above and illustrated are intended to be exemplary only. The scope is indicated by the appended claims.

1. An anode cooling table for supporting anodes during cooling, comprising:
a frame;
a heat absorbing layer defining a substantially continuous surface for being contacted with the anodes; and
a heat diffusing layer in contact with the frame and disposed between the frame and the heat absorbing layer, the heat absorbing layer in heat exchange relationship with the frame through the heat diffusing layer.

2. The anode cooling table of claim 1, comprising a plurality of slabs secured to the frame, the plurality of slabs having a top face for contacting the anodes and a bottom face opposed to the top face and facing the frame, the heat absorbing layer defined by a first portion of the plurality of slabs extending from the top face towards the bottom face, the heat diffusing layer defined by a second portion of the plurality of slabs extending from the bottom face towards the top face.

3. (canceled)

4. The anode cooling table of claim 2, comprising expansion joints disposed between each two adjacent ones of the plurality of slabs, the expansion joints resiliently deformable in a direction parallel to the top faces of the plurality of slabs.

5. The anode cooling table of claim 2, wherein each of the plurality of slabs has peripheral faces extending from the top faces to the bottom faces and chamfers at intersections between the top faces and the peripheral faces.

6. The anode cooling table of claim 5, comprising a securing arrangement for securing the plurality of slabs to the frame, the securing arrangement including cleats in abutment against the chamfers and fasteners extending through the cleats and threadingly engaged to the frame.

7. The anode cooling table of claim 6, wherein the securing arrangement includes biasing washers disposed between heads of the fasteners and the cleats, the biasing washers allowing vertical motions of the plurality of slabs in relationship to the frame about an axis perpendicular to the top faces.

8. The anode cooling table of claim 3, comprising biasing members disposed between the plurality of slabs and the frame, the plurality of slabs movable in a vertical direction normal to the plurality of slabs by resilient deformation of the biasing members.

9. (canceled)

10. The anode cooling table of claim 3, wherein the bottom faces of the plurality of slabs define grooves, and wherein the frame has a length in a longitudinal direction and a width in a transverse direction, the length greater than the width. the grooves extending in the longitudinal direction.

11. (canceled)

12. The anode cooling table of claim 2, wherein a material of the plurality of slabs has a heat capacity of at least 500 J/kg*K.

13. (canceled)

14. (canceled)

15. The anode cooling table of claim 1, wherein the heat absorbing layer is made of a material having a coefficient of thermal dilatation of less than 5*10-6%/K, an oxidation resistance of less than 1% of a weight variation at 950 degrees Celsius, a cold crushing strength of at least 150 MPa, a thermal conductivity of at least 120 W/m*K at 20 degrees Celsius, and a hardness of at least 1000 Kg/mm2 .

16. The anode cooling table of claim 1, wherein the heat diffusing layer includes a plurality of beams made of a second material having a thermal conductivity of at least 100 W/m*K, and wherein the plurality of beams are disposed one adjacent to the other to define a substantially continuous contact surface between the heat absorbing layer and the plurality of beams.

17. (canceled)

18. (canceled)

19. The anode cooling table of claim 16, wherein the plurality of beams are secured to the frame via pins protruding from the frame and received within apertures defined through flanges of the plurality of beams, and wherein the apertures are greater than the pins to allow thermal growth of the plurality of beams.

20. (canceled)

21. The anode cooling table of claim 16, wherein the heat diffusing layer is made of a material having a thermal capacity of at least 350 J/Kg*K, a thermal conductivity of at least 100 W/m*K, and a fusion temperature of at least 600 degrees Celsius.

22. (canceled)

23. (canceled)

24. (canceled)

25. (canceled)

26. (canceled)

27. (canceled)

28. (canceled)

29. An anode cooling table for supporting hot spent anodes during cooling, comprising:
a frame;
a plurality of heat-conducting slabs secured to the frame, the plurality of heat-conducting slabs made of a material having a heat capacity of at least 500 J/kg*K, the heat-conducting slabs extending from top faces for contacting the anodes to bottom faces opposed to the top faces and oriented toward the frame; and
a heat-transfer path extending from the top faces to an environment around the anode cooling table by conduction through a heat absorbing layer and by convection and/or radiation to the environment via a heat diffusing layer in heat exchange relationship with the heat absorbing layer.

30. The anode cooling table of claim 29, wherein the heat absorbing layer is defined by a first portion of the plurality of heat-conducting slabs extending from the top face towards the bottom face, the heat diffusing layer defined by a second portion of the plurality of heat-conducting slabs extending from the bottom face towards the top face.

31. The anode cooling table of claim 29, wherein each of the plurality of heat-conducting slabs has peripheral faces extending from the top faces to the bottom faces and chamfers at intersections between the top faces and the peripheral faces, cleats in abutment against the chamfers and fasteners extending through the cleats and threadingly engaged to the frame.

32. The anode cooling table of claim 29, comprising expansion joints disposed between each two adjacent ones of the plurality of heat-conducting slabs, the expansion joints resiliently deformable in a direction parallel to the top faces of the plurality of heat-conducting slabs.

33. The anode cooling table of claim 29, comprising biasing members disposed between the plurality of heat-conducting slabs and the frame, the plurality of heat-conducting slabs movable in a vertical direction normal to the plurality of heat-conducting slabs by resilient deformation of the biasing members.

34. The anode cooling table of claim 29, wherein the frame has a length in a longitudinal direction and a width in a transverse direction, the length greater than the width, the bottom faces of the plurality of slabs defining grooves extending in the longitudinal direction.
